(19) United States
(12) Patent Application Publication
(10) Pub. No.: US 2008/0313009 A1
(43) Pub. Date: Dec. 18, 2008

(54) METHOD FOR EXTRAPOLATING END-OF-LIFE RETURN RATE FROM SALES AND RETURN DATA

(76) Inventor: Holger Janssen, Richmond (CA)

Correspondence Address: PAUL, HASTINGS, JANOFSKY & WALKER LLP, 875 15th Street, NW, Washington, DC, 20005, US

(21) Appl. No.: 11/762,228

(22) Filed: Jun. 13, 2007

(51) Int. Cl. G06F 17/30

(52) U.S. Cl. 705/10

(57) ABSTRACT

A method for predicting product return rate behavior. The ratio of the cumulative product returns to cumulative sales affecting product returns is calculated. The cumulative sales affecting product returns is calculated based on a benchmark distribution related to the product return behavior. Accordingly, a manufacturer is afforded a more accurate prediction of end-of-life return rate at a time preceding the end-of-sales life of a product.

### BACKGROUND

1. Field of the Invention

Embodiments of the present invention relate generally to the field of product sales and distributions. More particularly, the present invention relates to estimating return rates of consumer products.

2. Background of the Invention

Product cycles for consumer goods, such as consumer electronics are becoming shorter each year (typical <1 year), leading to the need to accurately assess and predict product performance in a timely manner. One feature of particular interest to vendors of consumer products is the return rate of a product, especially a new product. This can be expressed, for example, as an end-of-life return rate (LRR), which denotes the total of all returns divided by the total of all sales for a given product. For a consumer product that has a sales life of one year (that is, is only offered as a new product for sale for one year), the value of the end-of-life return rate may be critical in determining the product's success. For example, even a product that has sales that greatly exceed expectations may fail to be a financial success for the product manufacturer if the end-of-life return rate is 20%, that is, if 20% of all products sold are eventually returned. In such a case, the product returns may end up causing a financial loss to the manufacturer for that given product.

The measured (or actual) end-of-life return rate (ALRR) is by definition a precise measure of the amount or, more accurately, the percentage of all products sold that are returned. However, the precise determination of ALRR takes place only after all sales and returns are complete. To the extent that returns are accepted after termination of sales at the end of the product life, the actual ALRR does not become calculated until weeks, months or years after the final product is sold. Thus, relying on an after-the-fact calculation of LRR would only give manufacturers a post-product-life analysis of the product performance in the marketplace, whether good or bad. Because manufacturers warranties may extend to a year after products are sold, and final product inventory may not be sold for some time after introduction of a new product, this type of analysis would not provide timely product return information that could be used by a manufacturer to make adjustments during the sales life of a product, especially during the early months of a product's life in which sales volume may be the greatest. In fact, by the time ALRR is determined for a given product, a first generation successor product may be nearing the end or have completed its sales life, and a second generation successor product may be well into production. Thus, manufacturers desire an accurate and early forecast of product return rates, which, for example, allows a manufacturer to focus product improvement efforts on products with higher than average return rates.

To address this problem, various methods of monitoring product performance during the sales life can be employed. Periodic monitoring can take place in which the total returns for a given period are compared to the total sales for that period. For example, a monthly return rate is calculated as this-month-returns/this-month-sales (%). Unfortunately, only a subset of users may return a purchased product within any given month, for example, within the first month of purchase. The monthly return rate is therefore often misleading. Many users return their product during a month subsequent to the initial month after purchase, thereby affecting the return rate of a subsequent month. For example during product ramp-up, sales increase each month and the monthly return rate may initially appear to be low because product sales continue to increase month-to month. Similarly, the monthly return rate climbs to infinity when returns are received after a product stops selling. Additionally, if products are sold largely at the end of a month, the return rate in that initial month may appear low, while the return rate in the following month may appear high due to the large volume of returns related to those products sold at the end of the previous month.

Another method for monitoring product returns involves calculating the cumulative return rate: all-returns-up-to-now/all-sales-up-to-now (%). Again, because consumers often take considerable time to return a newly purchased product, returns lag behind sales. As a result, the cumulative return rate will always be lower than the ALRR until the very last unit has been returned. As depicted in FIG. 1, the cumulative return rate typically increases asymptotically toward the ALRR until the very last unit is returned. The first returns are reported in week 5, leading to a gradual rise in the cumulative return rate, which results in an actual value of about 6.1% for the end-of-life return rate that is accurately measured from the last data points at the end of the sales life of the product. However, the cumulative return rate fails to reflect or approximate the 6.1% value for many weeks. For example after 16 weeks, the cumulative return rate is still only 4.3a %. Thus, a manufacturer attempting to assess the actual end-of-life return rate (LRR) may fail to make an accurate prediction based on the cumulative return rate after 4 months of sales, even though the life cycle of the product may be one half complete at that point. In fact, in the scenario depicted in FIG. 1, because production typically starts 2+ months before sales due to 1 month elapsed time for shipping and the need to “fill the distribution pipe,” over one half of the production volume for a product may have already left the factory at the end of the 4^{th} month of sales when the manufacturer still lacks an accurate picture of the end-of-life return rate. This problem is especially acute during product ramp-up, where the cumulative return rate is very low because many products are initially sold, but few are returned yet. The data in FIG. 1 represent a case in which sales and returns are measured weekly at the store. However, in some cases, returns are sent to a manufacturer and measured at the manufacturer's return center, resulting in a delay in reporting returns, such that the returns curve may lag sales by even greater than that shown in FIG. 1. Cumulative return rates can therefore be a very misleading indicator of product acceptance by the consumer during the first few months.

In view of the above, a need exists to better assess and evaluate product performance before the end of the sales lifetime of a product.

### BRIEF SUMMARY OF THE INVENTION

Embodiments of the present invention provide a system and method for accurate prediction of end-of-life return rates for a product long before the end of the sales life of the product and long before all returns of the product are received.

In one embodiment of the present invention, a method for monitoring product performance of a first product comprises a step of determining a benchmark return rate over time distribution. The benchmark return rate over time distribution may include the return rate over time data from a series of related products. For example, the benchmark distribution may comprise data collected from sales and returns of a series of consumer phone models. The benchmark distribution comprises a time span that includes a plurality of time periods that are each associated with a return rate for that time period. Preferably, the benchmark distribution comprises a time span in which a large majority of returns of the product or family of related products occurs. For example, the benchmark distribution can include a time span in which 90-100% of all returns occur. In one embodiment, the plurality of time periods comprises a duration over which greater than about 95% of returns are received.

In another step, the cumulative sales of the first product are determined. The cumulative sales represent all sales of the first product up to the time of determination of the cumulative sales. Preferably, the cumulative sales are determined before the end of the sales lifetime of the first product. In another step, the cumulative returns of the first product are determined. The cumulative returns represent all returns of the first product up to the time of determination of the cumulative sales. Based on the benchmark distribution, the volume of cumulative sales affecting returns is determined. The “cumulative sales affecting returns” represents that portion of the cumulative sales at the time of measurement of cumulative sales that is deemed to affect the cumulative returns at the time that the cumulative sales are determined. Thus, the cumulative sales affecting returns excludes a portion of cumulative sales that are deemed not to affect returns to date. An extrapolated end-of-life return rate is calculated based on the ratio of the cumulative returns to cumulative sales affecting returns. Accordingly, a manufacturer is afforded a more accurate prediction of end-of-life return rate at a time preceding the end-of-sales life of the first product.

In one embodiment of the present invention, the determination of an extrapolated end-of-life return rate is performed at a plurality of different times during a product lifecycle. Preferably, a first determination is performed at a time soon after first returns data are received. For example, an extrapolated life return rate for a product having sales and returns data produced weekly, may be calculated in a second or third week after initial returns data are collected, followed by a recalculation of the extrapolated life return rate in each subsequent week up to a desired end point.

In a further embodiment of the present invention, an extrapolated end of life return rate that is calculated early in a product cycle can be used to adjust the product treatment, wherein the actual end of life return rate is lower than if early product adjustments were not made.

### BRIEF DESCRIPTION OF THE DRAWINGS

FIG. 1 is a graph that depicts a known weekly return rate and a known cumulative return rate distribution.

FIG. 2 is a flowchart that depicts exemplary steps in a method for monitoring product performance and adjusting product treatment, in accordance with one embodiment of the present invention

FIG. 3a is a graph that illustrates an exemplary set of product return data that illustrates how a benchmark return distribution is created, in accordance with one embodiment of the present invention.

FIG. 3b depicts exemplary steps involved in a method for calculating a benchmark distribution, in accordance with another embodiment of the present invention.

FIG. 4 is a graph that depicts exemplary sales volume and monthly sales affecting current month's returns, using the distribution of FIG. 3a.

FIG. 5 is a graph that depicts monthly sales affecting total returns up to a current month, using the same data shown in FIG. 4 and the distribution depicted in FIG. 3a.

FIG. 6 is a graph that depicts exemplary monthly sales and return data and calculated cumulative return rate, as well as the extrapolated end-of life return rate that is calculated in accordance with an embodiment of the present invention based on the sales and return data for a product having a three year sales life.

FIG. 7 is a graph that shows another example of product return rate calculation, showing a comparison of different methods for calculating the return rate, including calculating extrapolated end-of-life return rate in accordance with an embodiment of the present invention.

FIG. 8 illustrates exemplary steps involved in a method for predicting product returns, in accordance with another embodiment of the present invention.

FIG. 9 is a graph that depicts the calculation of total sales affecting “next month's” returns, using the method depicted in FIG. 4 for calculating total sales affecting “this month's” returns.

FIG. 10 is a graph that shows an example of dynamic adjustment of product end of life return rate using a method for calculating extrapolated end of life return rate, in accordance with an embodiment of the present invention.

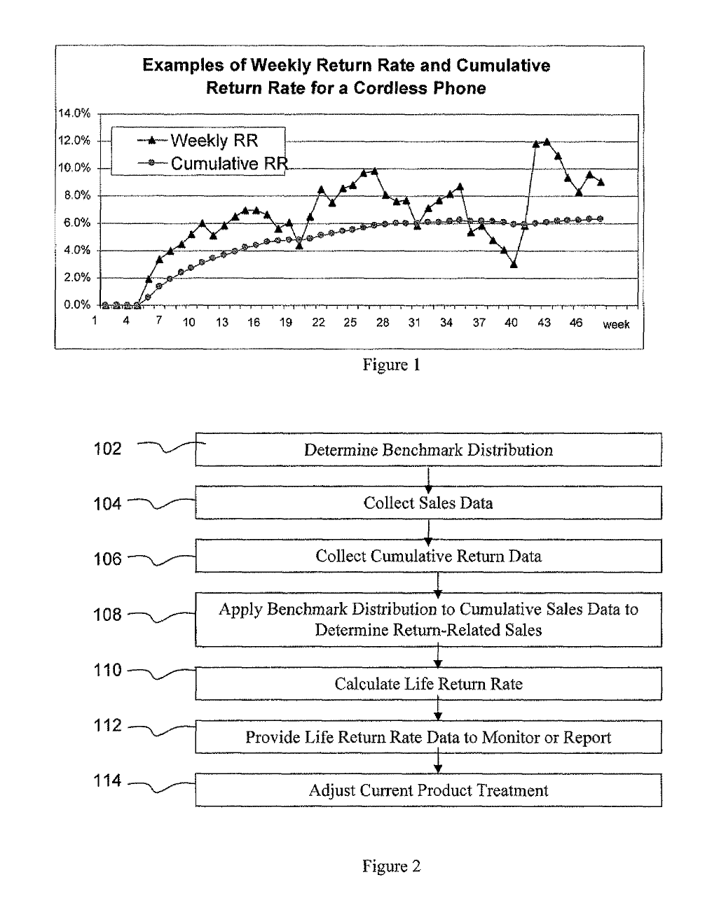

### DETAILED DESCRIPTION OF THE INVENTION

In order to better describe aspects of the invention, reference is made to the figures in the discussion to follow. In the following paragraphs, the terms “sales,” “cumulative sales,” “returns,” and “cumulative returns” generally refer to the volume of product units of sales and not to any dollar amount associated with sales or returns. One the other hand, the terms using the word rate generally reflect the ratio of one quantity to another, such as returns/sales, which can be expressed as a percentage or fractional amount.

A central feature of the present invention involves determination of life return rates for new products. The terms “actual end-of-life return rate” or “actual life return rate,” abbreviated as “ALRR”, as used herein, generally refer to the return rate for a given product after all sales of that product are complete and all possible returns have been made. The terms “extrapolated end-of-life return rate” or “extrapolated life return rate,” abbreviated as “ELRR”, as used herein, generally refer to an end-of-life return rate extrapolated in part from sales and returns data collected before all returns and/or sales have taken place, in accordance with embodiments of the present invention described below. The terms “end-of-life return rate” or “life return rate,” abbreviated as “LRR” refer to the general concept of the life return rate, and may be related to either ELRR or ALRR depending on the context, as will be apparent.

FIG. 2 depicts an exemplary method 100 for monitoring product performance and adjusting product treatment, in accordance with one embodiment of the present invention. Aspects of this invention particularly relate to assessing the return rate of new products introduced into the marketplace. A new product can be, for example, a new type of a consumer telephone, or a new model of an existing type of telephone. The use of the term “type” as opposed to “model” is only meant to convey a varying degree of difference between a new product and an existing set of products. Thus, a new type of telephone may include a combination of communication features not previously sold in a single phone, such as a hypothetical phone having internet phone capability combined with WiFi, TDMA, cellular, video monitoring, and Bluetooth compatibility. A new model phone generally refers to a phone having different features than previous models where the new features do not differ as substantially as between a new type of phone and previous types. Thus, a new model cordless phone might include a larger speaker than a previous model or a redesigned base station.

In view of the above, the term “new” product, as used in the context of this discussion, generally means a specific product that has not been sold previously, although products somewhat similar or very similar to the product may have been previously sold.

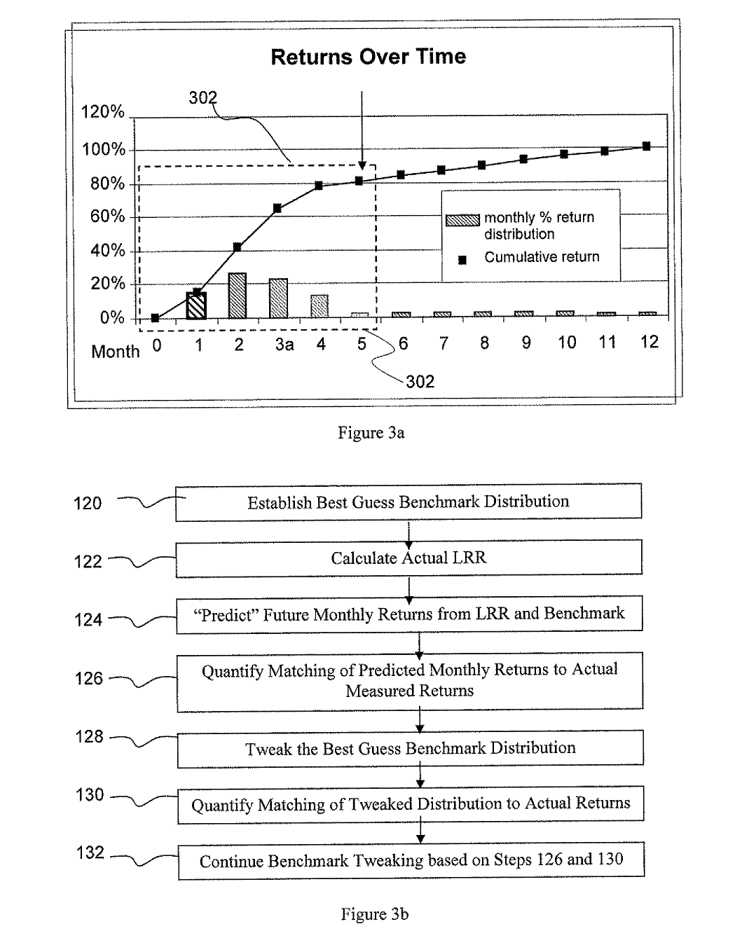

In the case of introducing a new model of phone, for example, a manufacturer may desire to predict the consumer acceptance of the new phone at an early stage of the product life cycle. In accordance with one aspect of the present invention, in step 102, a benchmark return rate distribution (or, simply, “benchmark distribution”) is established for a new product. Determination of the benchmark distribution is described in detail below with respect to FIG. 3a. The benchmark distribution reflects the return rate characteristics of a chosen benchmark product or set of products that is expected to exhibit behavior similar to the new product. For example, a given product benchmark distribution may indicate that that product or class of products has a peak return rate four months after the product is introduced and that 95% of returns occur within 6 months. Knowledge of this distribution can then be applied to calculate return rates for a new product, as described below.

In step 104, cumulative sales (CS) data for the new product are collected.

In step 106, the cumulative returns (CR) are collected, which reflects the total amount of product returns up to the time of collection (measurement) of the cumulative sales data. In accordance with embodiments of the present invention, the returns can be measured in different manners, as described in more detail below. For example, return data might be collected at a manufacturer collection point to which returned products are shipped. Alternatively, return data might be collected at point of sale by a vendor that reports daily, weekly, or monthly sales and returns directly to the manufacturer.

In step 108, the benchmark distribution is applied to the sales data to produce a return-related cumulative sales (RRCS) volume, as described in detail below. The return-related cumulative sales volume reflects the fact that, at the point of collection of the cumulative sales amount for a given product, not all of those sales would be expected to have generated returns. The volume of products of the total cumulative sales volume that are expected to have generated returns at the time of cumulative sales measurement is based upon the benchmark distribution. The return related cumulative sales volume can also be termed the “volume of sales affecting returns” up to the time of collection of cumulative sales. As explained further below, the volume of sales affecting returns is a measure of the proportion of products sales of the total cumulative sales that would have on average been expected to generate returns by the time of cumulative sales collection. The remaining portion of product sales up to the time of cumulative sales collection that would not have been expected to have generated returns as of the cumulative sales date is discarded for the purposes of estimating a life return rate.

In step 110, an extrapolated life return rate (also termed “extrapolated end-of-life return rate”) (ELRR) is calculated based upon the ratio of the cumulative returns to the return-related cumulative sales (ELRR=CR/RRCS). In this manner, as illustrated further below, at any time the ELRR can be calculated using cumulative sales/return data collected in conjunction with an appropriate benchmark distribution. By reducing the volume of cumulative sales to a return-related cumulative sales volume, application of the benchmark distribution serves to increase the calculated ELRR. In other words, because the total product sales at any point is greater than those sales that have generated returns (CS>RRCS), then CR/RRCS must be greater than CR/CS, which is the estimated life return rate based on uncorrected cumulative sales at that given point. As illustrated below, the method outlined in FIG. 2 results in more accurate prediction of an actual ALRR as compared to using simple cumulative sales and cumulative return data.

In step 112, the ELRR can be provided to the manufacturer or other interested party at a user interface, such as a computer monitor or as a hard copy report.

In step 114, the ELRR information can subsequently be used to adjust current product treatment. For example, a new product that exhibits a high ELRR early in its life cycle may be subject to retooling. In addition, new and existing product emphasis, pricing and promotional programs related to the new product, and related business decisions may be adjusted accordingly.

FIG. 3a illustrates an exemplary set of product return data that illustrates a benchmark return distribution, in accordance with one embodiment of the present invention. The data in FIG. 3a depicts return data for a product as a function of time, where return data is collected in each of twelve months. FIG. 3a shows that for sales occurring in month 0, 17% of total returns occur in month 1, 27% of total returns occur in month 2, and so on. FIG. 3a also shows that a total of 44% of returns have occurred in month 2 (17%+27%) and that all returns (i.e. 100%) have occurred by month 12.

The return rate data of FIG. 3a is expressed as a fractional return rate for each month as well as a cumulative return rate. The fractional return rate for any given month is based on the cumulative return rate being normalized to 100% when all returns are made. The data reflect the assumption that all sales take place at month zero. Thus, for a given amount of sales at month zero, all returns of products that are sold in month zero are completed by month 12. If the total cumulative returns at month 12 represents, for example, 10% of sales, then by definition, at month 12, the cumulative return rate would reach 10%. However, the data in FIG. 3a is normalized so that the data reflects return behavior as a function of total returns, rather than as a function of total sales. The percentage returns are calculated by determining the total returns for each month and dividing by the actual total returns at the end of life of the product. Thus, whether a product results in a total return rate of 15% or 5%, at month 12, 100% of those products will have been returned.

Accordingly, based on an initial one time sales event at time zero, the data in FIG. 3a reflects the monthly distribution of all returns that will occur in that month as a percentage of the total amount of returns that will occur at the end of the return cycle. Using a benchmark month, such as the sales month of the product, the data thereby shows the relative likelihood of a product being returned in any given month after the sale with respect to the likelihood of the product being returned in any other months after the sale. This relative return rate behavior has been found to be valid independently of absolute product return rates for certain products. For example, the data of FIG. 3a illustrate that a peak in return rate occurs in month two after sale, and that 90% of products are returned by month eight. For a given product, or product type, this distribution would be expected to apply regardless of whether the total return rate at month twelve is 20% of 5%. In other words, if the distribution of FIG. 3a were found to apply to telephones, the curve indicates that the product return rate will peak at two months after sale. Because it does not contain absolute return rate data, this curve would then be expected to apply in the case of a quality phone that has an overall return rate of only 3a % at the end of its life cycle, as well as for a poorly constructed phone that has the 20% return rate at the end of life.

In accordance with embodiments of the present invention, a benchmark distribution, such as that shown in FIG. 3a, can be created by collecting return rate data for a designated product or set of products. For example, a cellular telephone manufacturer contemplating introducing a new cellular telephone into the market may wish to estimate the return rate of the new phone. The manufacturer can create a benchmark distribution based on previous cellular telephone return rate data for cellular telephones similar to the model to be introduced. Alternatively, the manufacturer may wish to rely on a distribution that reflects a larger set of cellular telephone products, some of which may differ significantly from the new model, if it is determined that the historical return rate distribution does not differ markedly between cellular telephone models. An advantage of using the larger set of product data to form a benchmark distribution is that the data may be more statistically significant than that collected for just one cellular phone model.

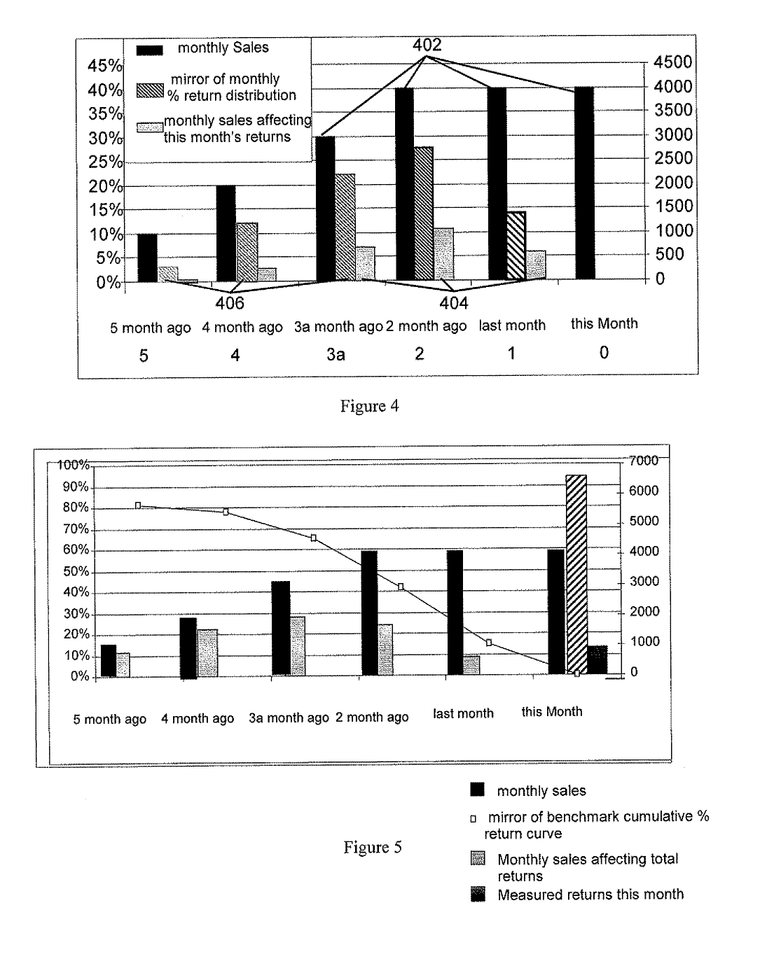

FIGS. 4 and 5 illustrate details of an exemplary application of a benchmark distribution to a set of new product sales, in accordance with an embodiment of the present invention. In FIGS. 4 and 5, the benchmark distribution shown in FIG. 3a is used to determine the cumulative return-related sales for the exemplary product sales history shown.

FIG. 4 is a composite graph that depicts an exemplary product sales volume history and return-related sales (sales affecting this month's returns) volume history for five months preceding a current month in which the data is analyzed. In the discussion to follow, it is noted that the terms “this month,” “last month,” and the like are used in lieu of other possible equivalent terms, such as month 0, month 1, etc. In particular, “this month” generally denotes the time at which cumulative sales, cumulative returns, and LRR are being determined. The solid histograms represent total monthly sales for an exemplary new product, which could be a new cordless telephone model or a new type of cordless phone. In the initial month (five months ago), the phone sales total 1000 units and increase to a value of 4000 units by the fourth month (two months ago), after which the sales volume is constant until the time of measurement of cumulative sales (this month).

FIG. 4 also shows the return-related sales 404 (i.e., the subset of the sales for any given past month that affects the returns in this month) (grey histograms) for monthly sales made up to the time of measurement (this month) that affect this month's returns, as well as a monthly percentage 406 (histograms with hatching) that represents a mirror image of the monthly return distribution of FIG. 3a. In each month, the return-related sales are a fractional portion of the total sales for that month that is equivalent to the fraction of the total lifetime returns for products sold in that month that would be returned during the current month (this month).

The return-related sales data are determined by assuming that the product return behavior of the new phone will mimic the behavior determined from the benchmark distribution shown in FIG. 3a. In particular, the return-related sales volume is determined by taking a mirror image of the monthly benchmark distribution (histogram data shown in FIG. 3a) and applying the mirror image distribution 406 to the monthly total sales histograms 402. For example, FIG. 3a depicts that no returns occur in month zero and 17% of all eventual returns of a product occur within the first month after the sales month. Accordingly, in FIG. 4, the histogram plot that depicts the mirror image distribution shows zero percent for this month and 17% for last month. For any given month, multiplying the % value depicted in the mirror image distribution times the volume of sales for that month yields the return-related sales for that month (% of sales affecting this month's return). Thus, there are no return-related sales for this month and there are 600 return related sales from last month, which is the equivalent of 17% times the 4000 sales made last month.

To understand in more detail why the above procedure is used to determine return-related sales, it is helpful to consider, using the “last month's sales” from FIG. 4, that a certain amount of all the 4000 phones sold will be eventually returned. Of those phones from last month's sales that are eventually returned, in accordance with the benchmark distribution of FIG. 3a, 17% are returned in the first month after sales, 27% more in the second month, 23% more in the third month, etc. After about twelve months from last month, no more phones from last month's 4000 sales will be returned if the returns follow the distribution of FIG. 3a. Thus, any product returns accepted more than a year from last month will not be related to (affected by) last months 4000 sales (those phones will have been kept forever by their owners or returned). Thus, in order to accurately assess the effect of phone sales from last month, since 17% of any eventual phone returns from phones sold last month will occur in the first month following sale (this month), one can allocate 600 sales (17%) of phones from last month's 4000 sales as affecting this months returns. Similarly, sales of phones from each previous month will affect returns this month. For example, of the 4000 phones sold two months ago, 27% (1080) are designated as related to this month's returns, since the distribution in FIG. 3a shows that 27% of all the returns of that product will occur two months after the benchmark products sales.

In sum, FIG. 4 illustrates that a total of 18,000 products (such as phones) were sold in the current month and 5 months preceding, which may represent the first six months of the new product life. Of those 18,000 sales, only 2,660 sales (the total of sales over the last five months related to this month's returns) are considered to have an effect on this month's returns (not shown). The effect on product returns for the remaining 15,340 phones sold over the last six months is experienced in the preceding months and in subsequent months according to the distribution of FIG. 3a as applied to each month's sales.

To determine an accurate LRR as of this month, the type of procedure applied in FIG. 4 to the current month is applied to all months preceding and including “this month,” as described below. FIG. 5 depicts on a monthly basis the amount of sales that are deemed to affect total returns (are return-related sales) using the same sales data shown in FIG. 4 and the benchmark distribution of FIG. 3a. In FIG. 5, sales from each month are designated as affecting total returns (return-related) as of this month according to the cumulative return distribution of FIG. 3a. “Total returns” refers to any returns received up to the present. Unlike FIG. 4, which only depicts monthly sales affecting this month's returns, the data shown in FIG. 5 in effect combines the return-related sales data shown in FIG. 4 with a series of similar monthly data that could be calculated for each of the preceding five months.

For example, the total return-related sales for the period two months ago includes, in addition to the 1080 assigned to this month (see FIG. 4), 600 return-related sales that would be associated with returns made last month. The additional 600 return-related sales assigned to the two-month-ago period are attributed to the fact that 4000 units were sold two months ago, and 15% of returns from those sales would occur in the subsequent month (last month). Thus, 15%, or 600 sales, from two months ago are designated as related to last month's returns, and 27%, or 1080 sales, from two months ago are designated as those that affect total returns, producing a grand total of 1680 sales from two months ago that are designated as affecting total returns as of this month (i.e., returns received last month or this month). Similarly, the data from three months ago reflects sales designated as affecting returns that took place two months ago, one month ago, and this month.

To determine the sales affecting total returns for any given month preceding a measuring month, the total return-related sales for each preceding month can be calculated by reversing along a time axis the cumulative distribution of FIG. 3a, and mapping the reversed distribution onto the sales data of FIG. 4. This process produces the line curve of FIG. 5 and appropriately aligns the monthly data of the line curve with the monthly sales data, as discussed below.

The line curve of FIG. 5 illustrates the percentage of total sales for each month that are designated as affecting returns as of this month. Notably, the line curve of FIG. 5 is the mirror image along a time axis of the first five months of the cumulative distribution curve shown in FIG. 3a, which depicts an increase in the cumulative product return percent (rate) for each month going forward in time after a benchmark month. As a mirror image of the distribution in FIG. 3a, the distribution curve in FIG. 5 depicts that the cumulative return percent increases for each month going back in time from the benchmark month, which is the present month. For example, the data of FIG. 3a show that, five months after sales of products in month zero, 81% of any returns from those product sales in month zero will have taken place. This means, in the context of FIG. 5, that for any products sold five months ago, 81% of any eventual returns have already taken place as of this month.

The mapping process comprises assigning a cumulative return percentage determined in each month of the benchmark distribution to a corresponding month in the sales history graph of FIG. 5. The criterion for determining the correspondence between product sales months of FIG. 5 and benchmark distribution months of FIG. 3a (which figure is used to produce the mirror image line graph of FIG. 5) is that a sales history month (FIG. 5) and corresponding benchmark distribution month (FIG. 3a) are each separated in time by the same amount from a measuring point (month). Thus, month 5 in the benchmark distribution of FIG. 3a is separated by five months from month 0, which is the measuring month. Similarly, month “five months ago” is separated by five months from “this month,” which is the measuring month in which cumulative sales and returns are recorded. Notably, only applicable months within the benchmark distribution (indicated inside the dotted box 302 in FIG. 3a) are used to perform the mapping process. Thus, for the example shown in FIGS. 3a-5, the product has only been on sale six months, which means that there is no month “six months ago.” Accordingly, only the first six months (months zero to five) of the benchmark distribution are used to create the mirror distribution of FIG. 5.

Accordingly, in FIG. 5, the 1000 sales that took place during month “five months ago” results in 81% (810) of 1000 units being designated as being return-related as of the present (affecting total returns). The calculation of sales affecting total returns (as of this month) for each preceding sales month thus involves multiplying the cumulative percentage of returns shown in the line graph of FIG. 5 for each preceding month with the actual sales volume for that month. As depicted in FIG. 5, the total return-related sales for all preceding months as of this month are 6600 units, much lower than the total sales of 18,000 as of this month.

Based on the total return-related sales, the extrapolated end-of-life return rate ELRR for the product data of FIGS. 4 and 5 can simply be calculated as the (total returns up to now)/(total return-related sales). Thus, if cumulative returns as of this month were 660, the calculated ELRR would be 660/6600, or 10%. This is much higher than the 3a.6% value calculated using the known cumulative method (660 cumulative returns/18,000 cumulative sales).

In the figures that follow, examples are given as to how the estimation of LRR is improved using the method outlined above with respect to FIGS. 3a-5. Each figure illustrates both a set of data derived in accordance with embodiments of the present invention, and a set of data derived using the cumulative method described above.

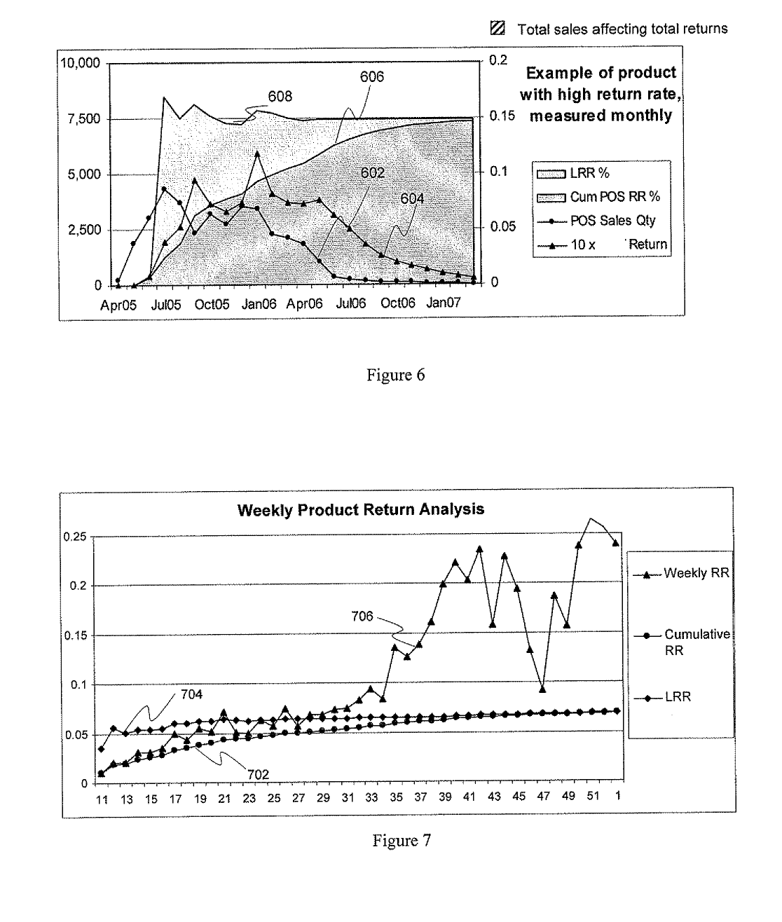

FIG. 6 depicts exemplary monthly sales 602 and return data 604 (multiplied by a factor of 10 for legibility) and calculated cumulative return rate 606 (dark area) based on the sales and return data for a product having a three year sales life. As shown, the eventual end-of-life return rate is just under 15% at the end of the second year after sales have ceased. In actuality, returns would continue for months beyond the last month of sale. However, because sales were so low in the months immediately preceding the end of sales, any future returns based on those sales would be very small and would not affect the end of life return rate significantly. Therefore, the data is only shown plotted until the end of the sales period, which is clearly asymptotically approaching about 15%. Notably, in the initial 6 months, the cumulative return rate is only about 7% and only somewhat over 10% after one year. Thus, the cumulative return rate calculated based on data taken through the first year after sales begins seriously underestimates the eventual ALRR.

In contrast the upper shaded ELRR curve 608 is derived according to the method of the present invention described generally with respect to FIGS. 2-5. An appropriate benchmark distribution is applied to the cumulative sales so that cumulative sales affecting returns is determined at each point in time that is plotted on the curve. From the cumulative return related sales, the ELRR curve 608 is derived by dividing the cumulative returns by the cumulative return related sales data (total sales affecting returns up to the point in time plotted). After 3a months, the upper curve 608 already predicts an LRR of about 11% and remains relatively flat with minor fluctuations thereafter. Thus, the curve 608 derived in accordance with the method of the present invention provides an accurate and early prediction of the end-of-life return rate, which the invention can determine months or years before such an assessment could be derived from the cumulative sales data.

FIG. 7 shows another example of product return rate calculation, showing a comparison of different methods for calculating the return rate. Return rates are calculated every week beginning with week eleven and ending at week fifty-two, by which time most product returns have been received. Both weekly and cumulative calculations are shown. The conventional weekly return rate is calculated as (this weeks returns)/(this weeks sales). The cumulative return rate 702 is calculated conventionally as (total returns)/(total sales up till now). The curves 704, 706 are calculated in accordance with the method of the present invention as described above with respect to FIGS. 2-5, except that calculations are performed weekly. Thus, the weekly calculations curve 706 reflects the quotient of this week's returns divided by this week's sales. The cumulative calculations curve 704 reflects the quotient of the sum of all returns up to this week divided by the sum of all sales of previous weeks that affect returns in any week up to the present week. Again, the latter curve 704 much more quickly approximates the eventual ALRR value of about 7%. At week twelve, the calculated ELRR 704 is already about 6%, while the conventional cumulative return rate 702 yields a value closer to 2%.

In accordance with further embodiments of the present invention, the manner in which a benchmark distribution is chosen to apply to a given product can be tailored to account for other factors. For example, the return rate distribution may vary according to product sales channel or return channel. Thus, individual return rate distributions may be derived based on whether the product is bought online as opposed to a big box retailer. Similarly, distributions may differ if returns are accepted through a manufacturer collection point as opposed to a point of sale store. In the latter example, the lag between actual product return from a customer and the reporting of returns may be expected to vary depending on the return channel, since a retailer may receive and report returns more or less quickly to the manufacturer than a manufacturer's warehouse facility. Each of these factors can be taken into account in tailoring the appropriate distribution to apply to actual returns and sales.

In addition, the protocol for sales and returns data collection for a new product need not match that used for determination of a benchmark distribution that is applied to the sales/return data. For example, a benchmark distribution might be expressed as a monthly return rate distribution, Nevertheless, it may be desirable to collect sales/return data for a new product on a weekly basis to more accurately and quickly make an LRR determination. The procedures outlined above with respect to FIGS. 3a-5 could still be generally applied in the case of using a monthly benchmark distribution and weekly sales/returns data. For example, the benchmark distribution could be interpolated to produce a series of cumulative return rate data points that are spaced by one week rather than one month and thereby can map directly onto the weekly sales/returns data of the new product to generate accurate return-related sales data for each week, and thereby accurate cumulative return-related sales that can be measured each week.

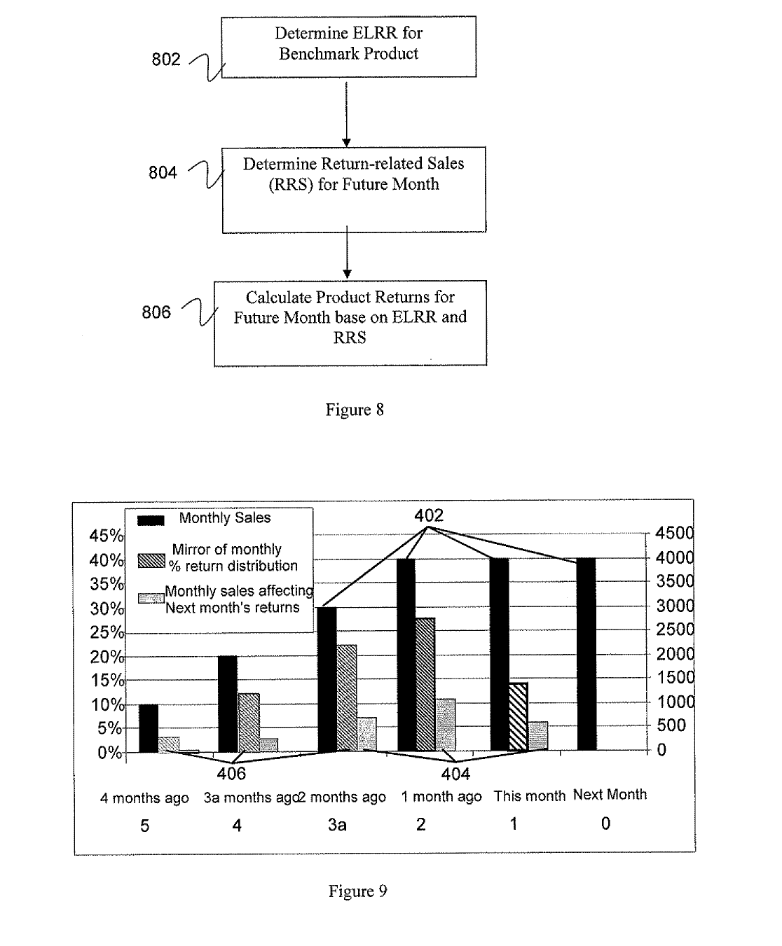

In addition to providing early information about the relative success of a product, determination of an ELRR for a product can be used to predict returns of the product in future months. FIG. 8 illustrates exemplary steps involved in a method for predicting product returns, in accordance with another embodiment of the present invention. In step 802, the ELRR for the product is determined. Determination of ELRR takes place in accordance with embodiments of the invention described above with respect to FIGS. 3a-5. Preferably, the ELRR represents an ELRR calculated using data that is current as of the time of predicting product returns. Thus, for example, at a month “0,” the ELRR is calculated based on total returns as of month 0 divided by total sales affecting total returns as of month 0.

In step 804, for each subsequent month of interest, the volume of total sales affecting returns for that month of interest is calculated. Preferably, total sales affecting returns for each subsequent month are calculated in accordance with the method described above with respect to FIG. 4. To further illustrate this point, FIG. 9 replots the data shown in FIG. 4. FIG. 9 is a graph that depicts the calculation of total sales affecting “next month's” returns, using the same steps described above and depicted in FIG. 4 for calculating total sales affecting “this month's” returns. The only difference between FIGS. 4 and 9 is that the frame of reference (this month) is shifted back by one month in FIG. 9. Thus, the volume of total sales affecting next month's returns in FIG. 9 is represented by the sum of all the lightly shaded histograms.

In step 806, the total returns for a future month of interest are calculated by multiplying the ELRR for the product times the total sales affecting returns for that month. Thus, referring to the example of FIG. 9 once more, if the total returns affecting next month's sales were calculated to be 2700, and the LRR were determined to be 10%, product returns for next month would be predicted to be 270.

For calculation of returns in months beyond “next month,” the method described with respect to step 804 can be modified to account for the fact that “next month's” sales are as yet unknown. For example, in order to calculate the total sales affecting returns in month “two months from now” (not shown in FIG. 9) sales from “next month” must be taken into account that will affect returns in month “two months from now.” This can be accomplished by postulating the amount of sales that will occur “next month” (for example but not limited to using a sales forecast) and applying the benchmark distribution to the postulated sales to determine “next month's” contribution to total sales affecting returns in month “two months from now.” Table I below illustrates exemplary data in which future returns are estimated as of August, 2006 for the next two months in accordance with the method described above with respect to FIG. 9. An ELRR of 15.4% was determined in accordance with the method described in FIGS. 3a to 5 based on the actual sales and return from March 2006 to August 2006. For September 2006, actual sales data from March-August 2006 is used to calculate total sales affecting returns for the month of September, 2006, which is multiplied by an LRR of 15.4% to predict a volume of 395 returns for the month. The volume of returns (455) that is predicted for October, 2006 is based on actual sales between March-August 2006 and postulated sales for September 2006.

TABLE I

| | | 2006 | 2006 | 2006 | 2006 | 2006 | 2006 | 2006 | 2006 |
|---|---|---|---|---|---|---|---|---|---|
| Model | | MARCH | APRIL | MAY | JUNE | JULY | AUGUST | SEPT. | OCTOBER |
| Name | | 200612 | 200701 | 200702 | 200703 | 200704 | 200705 | 200706 | 200707 |
| x | Qty Sold | 1000 | 3500 | 5000 | 5000 | 4000 | 4000 | 4000 | 5000 |
| | (DM + LC) | | | | | | | | |
| x | Return | | | −6 | −45 | −211 | −312 | −395 | −455 |
| X | LRR | | | | | | 15.4% | | |

The methods described above with respect to FIGS. 3a-9 that are used for calculating entities such as return-related sales, life return rate, and future returns are in part predicated on determination of a benchmark distribution that describes the distribution of returns over time that occur after product sales that take place at an initial time (month 0 in FIG. 3a). In theory, as described above, a benchmark distribution can be determined for a given product if all the sales occur at once (for example, in month zero), so that the returns received in subsequent months are all referenced to an initial measuring month when all sales take place. However, in a typical product lifecycle, not all sales take place in a single week or month. Accordingly, product sales typically have substantial overlap with product returns. As described below for such a case, in order to determine an accurate benchmark distribution based on overlapping sales and returns data, several steps are employed.

FIG. 3b depicts exemplary steps in a method for determining a benchmark distribution, in accordance with a further embodiment of the present invention. In step 120, a best guess distribution is postulated. The best guess distribution can be based on historical data of related products, for example. The best guess distribution represents a distribution that corresponds to a distribution of periodic returns received subsequent to sales of a product at one time, as described above with respect to FIG. 3a. For example, a user could simply apply an existing benchmark distribution of the form shown in FIG. 3a.

In step 122, the actual life return rate is determined for a benchmark product whose life cycle is complete. This simply involves calculating the quotient of total returns to total sales of the benchmark product.

In step 124, the best guess benchmark distribution together with the actual life return rate are applied to the benchmark product sales data for a given set of months to predict the returns for subsequent months. This method can involve, for example, the steps generally described above with respect to FIGS. 8 and 9. In this case, since the actual sales life and returns of the benchmark product may be complete, the actual life return rate ALRR for the product can be used. An initial set of months having historical sales data for the benchmark product is selected and the best guess benchmark distribution applied to the sales data for those months to generate a series of monthly return-related sales. Similar to the method described above with respect to FIGS. 8 and 9, the ALRR value is multiplied by the return-related sales calculated for each month subsequent to the initial months to generate a “predicted” monthly returns volume for that subsequent month. In this case, however, because the product life cycle is complete, the actual returns volume is already known for the “subsequent” months. Thus, if the best guess benchmark distribution is accurate, the multiplying of the ALRR times the return-related sales calculated for each subsequent month should yield a value for product returns that corresponds to the actually measured value for that month.

In step 126, a correlation function is used to quantify how close the predicted monthly returns are for subsequent months to the actual measured returns for those months.

In step 128, the best guess benchmark distribution is incrementally changed (tweaked) such that the distribution is slightly altered.

In step 130, the results of application of the tweaked best guess benchmark distribution are quantified using the same correlation function as was applied in step 126 to see how closely application of the tweaked distribution matches the actual return results.

In step 132, the results of steps 130 and 126 are compared. If the correlation function has improved, i.e., if the benchmark distribution used in step 130 yields a better correlation than the benchmark distribution used in step 126, then the tweaking was “good.” If not (correlation has degraded), the tweaking should be reversed. By systematically and repeatedly tweaking each parameter of the return-over-time distribution (i.e., increase or decrease the % return attributed to each of the 12 months of the return over time distribution of FIG. 3a) so that the correlation function increases, one finally obtains an optimized return over time distribution (i.e., benchmark distribution) tailored to the historic data that was analyzed. Based on a comparison of results the above steps 128-130 can be repeated to monitor when the direction of benchmark distribution tweaking produces improvement in the correlation between predicted and actual returns. This process can be repeated until the correlation approaches a desired value, or until no further tweaking of any of the parameter improves the correlation, or further tweaking of any of the % return for any of the 12 month results in reducing the correlation. The tweaking of the distribution thus comprises a local optimization algorithm used to arrive at a benchmark distribution yielding the best correlation, which can then be used for subsequent ELRR determination for other products, as described above.

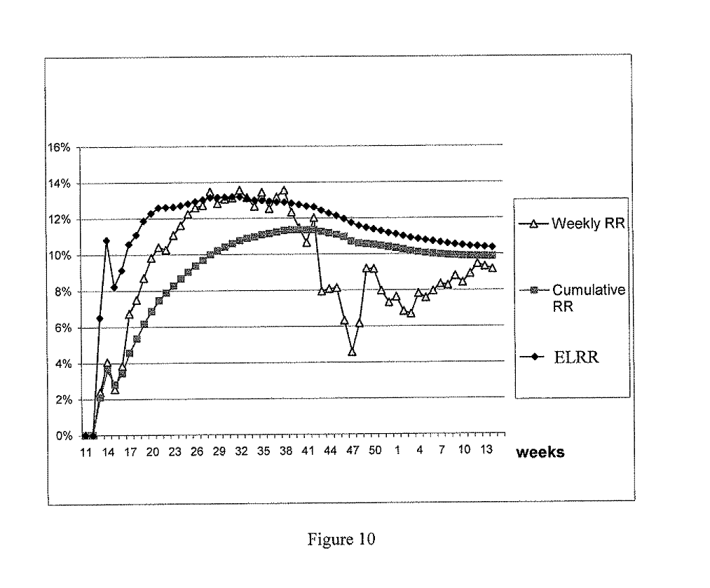

The ability to predict LRR for a product early in the product life cycle afforded by the above-described embodiments also facilitates dynamic adjustment of product return rate behavior. For example, in accordance with embodiments of the present invention generally depicted at steps 112-114, the determination of ELRR early in a product life cycle may allow a manufacturer to identify and fix a problem associated with a product that exhibits a high early ELRR. FIG. 10 is a graph that shows an exemplary return rate data that reflect the dynamic adjustment of product end of life return rate using a method for calculating extrapolated end of life return rate, in accordance with an embodiment of the present invention. In FIG. 8, in the initial weeks (14-16) in which return data was collected, a large ELRR in excess of 11% was already identified for the product in question. Notably, this large ELRR was flagged before the cumulative return rate reached even 4%. Accordingly, immediate work was begun to identify the product problem resulting in the high level of returns and to make product adjustment, which was performed during subsequent weeks. Soon thereafter, improved products began to ship, which was confirmed by steep drop in weekly return rate after about week 40, and foreshadowed by the drop in ELRR between weeks 30 and 40.

Notably, the ELRR is observed to decrease well before a similar decrease is observed in the cumulative return rate. A manufacturer simply relying on cumulative return rate data to assess the success of a product adjustment would thus have to wait much longer to confirm that success. Thus, in accordance with another embodiment of the present invention, the continuous monitoring of ELRR in a dynamic context in which the eventual LRR is altered by user intervention from what would otherwise result, provides both a means to trigger intervention and a means for early assessment of the success of that intervention.

In addition, as described herein, the tangible output of the system and method of the present invention includes the creation of output, such as weekly or monthly sales logs, as well as weekly or monthly returns logs. The use of the weekly or monthly sales and/or returns logs can be fed to the user's backend systems, and the use of these tangible results are important aspects of the present invention. Thus, the system and method (as implemented through technology) described herein produce these and other tangible results.

In one embodiment of the present invention, a system for predicting product LRR rates is a web-based tool capable of operating standalone in a trusted environment and can be launched within any designated user working environment. The system has automated links to a product sales and returns data, and provides a platform to authenticate users, wherein the user can obtain up-to-date product sales and returns data at any time.

In accordance with an embodiment of the present invention, instructions adapted to be executed by a processor to perform a method are stored on a computer-readable medium. The computer-readable medium can be accessed by a processor suitable for executing instructions adapted to be executed. The terms “instructions configured to be executed” and “instructions to be executed” are meant to encompass any instructions that are ready to be executed in their present form (e.g., machine code) by a processor, or require further manipulation (e.g., compilation, decryption, or provided with an access code, etc.) to be ready to be executed by a processor.

In the context of this document, a “computer-readable medium” can be any means that can contain, store, communicate, propagate, or transport the program for use by or in connection with the instruction execution system, apparatus, or device. The computer readable medium can be, for example, but is not limited to, an electronic, magnetic, optical, electromagnetic, infrared, or semi-conductor system, apparatus, device, or propagation medium. More specific examples (a non-exhaustive list) of computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM). Note that the computer-readable medium could even be paper or another suitable medium upon which the program is printed, as the program can be electronically captured, via for instance, optical scanning of the paper or other medium, then compiled, interpreted, or otherwise processed in a suitable manner, if necessary, and then stored in a computer memory.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method for product monitoring, comprising:
determining a benchmark distribution comprising a product return rate-over-time distribution based on a designated product set;
receiving at a first time sales data corresponding to a first product, the cumulative sales data including all sales of the first product up to the first time;
receiving returns data corresponding to the first product, the cumulative returns data including all returns of the first product up to the first time;
applying the benchmark distribution to the sales data to obtain a cumulative return-related sales volume; and
calculating an end-of-life return rate for the first product based on the quotient of cumulative returns divided by the cumulative return-related sales volume.

2. The method of claim 1, wherein the determining a benchmark distribution comprises:
collecting benchmark return data for a given product or group of products, the benchmark return data comprising a plurality of time periods in each of which return data is collected and aggregated; and
calculating a percent return rate distribution comprising a percent return rate for each of the plurality of time periods.

3. The method of claim 2, wherein the plurality of time periods comprises a duration over which greater than about 95% of returns are received.

4. The method of claim 1, wherein the benchmark distribution corresponds to sales of a product through a similar sales channel as the first product.

5. The method of claim 1, wherein the benchmark distribution corresponds to sales of a product substantially similar to the first product.

6. The method of claim 1, wherein the cumulative sales data and the cumulative returns data each comprise a plurality of respective periodic sales and returns data that is collected over a plurality of collection periods up to the first time.

7. The method of claim 1, wherein the cumulative returns data is measured at a retailer level.

8. The method of claim 1, wherein the cumulative returns data is measured at a manufacturer level.

9. The method of claim 1, wherein the sales data is measured at a point of sales to and end user.

10. The method of claim 1, wherein the sales data is measured at a point where sales are from manufacturer to retailer.

11. The method of claim 6, wherein the cumulative data sales and the cumulative returns data are both collected on one of a quarterly, monthly, biweekly, weekly, and daily basis.

12. The method of claim 6, wherein the applying the benchmark distribution comprises:
determining a cumulative return percent for each respective collection period;
multiplying the cumulative return percent times a sales volume for the each respective collection period to obtain a return-related sales volume for the each respective collection period; and
aggregating the return-related sales volume for all the collection periods to obtain the cumulative return-related sales volume.

13. The method of claim 12, wherein the determining the cumulative return percent comprises:
calculating a cumulative return percent for a plurality of contiguous time periods of the benchmark distribution beginning with a time of initial returns; and
mapping the cumulative return percent for the plurality of contiguous time periods to respective collection periods that comprise the plurality of collection periods.

14. The method of claim 13, wherein the mapping the cumulative return percent comprises:
determining a measuring point for each of the benchmark distribution and the sales data; and
determining one or more time periods of the plurality of contiguous time periods of the benchmark distribution that each corresponds to a respective collection period, wherein the respective time period and collection period are each separated in time by a same amount from their respective measuring points.

15. The method of claim 1, further comprising:
providing the calculated end-of-life return rate as output in one or more of tabular and graphical format; and
displaying the output in one or more of a user interface and a hardcopy print out.

16. The method of claim 1, further comprising iteratively repeating the receiving the cumulative sales data, the receiving the cumulative returns data, the applying the benchmark distribution, and the calculating an end-of-life return rate for a series of subsequent times to determine a series of corresponding end-of-life return rates for the series of subsequent times.

17. The method of claim 16, further comprising adjusting product treatment based on the end-of-life return rate calculated.

18. The method of claim 17, wherein the adjusting product treatment comprises one or more of adjusting production of the first product based on the end-of-life return rate, adjusting at least one of pricing and promotional programs related to the first product based on the end-of life return rate, and retooling the first product based on a high end-of-life return rate.

19. The method of claim 6, wherein the plurality of time periods used to generate the benchmark distribution each have a different size than that of the plurality of collection periods.

20. The method of claim 1, wherein the collecting the benchmark distribution comprises:
calculating an actual life return rate for the designated product set;
establishing a best guess benchmark distribution;
predicting monthly returns for the designated product set based on application of the benchmark distribution to actual sales data from the designated product set;
determining a difference between the predicted monthly returns to actual monthly returns of the designated product set; and
modifying the best guess benchmark distribution to reduce the difference between predicted monthly returns and the actual monthly returns.

21. The method of claim 20, wherein the predicting the monthly returns comprises:
determining a volume of return related sales associated with a first group of months for at least one future month; and
calculating a product of the return-related sales and the life return rate for the at least one future month.

22. The method of claim 9, wherein the cumulative returns data is measured at a retailer level.

23. The method of claim 9, wherein the cumulative returns data is measured at a manufacturer level.

24. A method for predicting product returns, comprising:
calculating an extrapolated life return rate for a first product;
determining return-related sales of a first product at one or more future measuring periods; and
determining a volume of product returns for the first product in the one or more future measuring periods based on a product of the extrapolated life return rate of the first product and the return related sales for the one or more future measuring periods.

25. The method of claim 24, wherein the calculating the extrapolated life return rate comprises
determining a benchmark distribution comprising a product return rate-over-time distribution based on a designated product set;
receiving at a first time cumulative sales data corresponding to the first product, the cumulative sales data including all sales of the first product up to the first time;
receiving cumulative returns data corresponding to the first product, the cumulative returns data including all returns of the first product up to the first time;
applying the benchmark distribution to the cumulative sales data to obtain a cumulative return-related sales volume up to the first time; and
calculating the life return rate for the first product based on the quotient of cumulative returns divided by the cumulative return-related sales volume.

26. The method of claim 24, wherein the determining the return-related sales of the first product comprises determining return-related sales of the first product at one or more additional times that each correspond to a respective future measuring period.

27. The method of claim 26, wherein the determining the return-related sales at one or more additional times comprises:
estimating sales volume for at least one future measuring period; and
determining return-related sales corresponding to the at least one future measuring period based on the estimated sales volume.
